(19) United States
(12) Patent Application Publication
(10) Pub. No.: US 2007/0103538 A1
(43) Pub. Date: May 10, 2007

(54) Thermal printing head with two-dimensional array of resistive heating elements, and method for printing using same

(76) Inventors: Brian D. Busch, Sudbury, MA (US); Chien Liu, Wayland, MA (US); Stephen J. Telfer, Arlington, MA (US); Juan Carlos Van Dijk, Sudbury, MA (US); William T. Vetterling, Lexington, MA (US)

Correspondence Address: FOLEY & LARDNER LLP, 111 HUNTINGTON AVENUE, 26TH FLOOR, BOSTON, MA, 02199-7610, US

(21) Appl. No.: 11/593,218

(22) Filed: Nov. 6, 2006

Related U.S. Application Data
(60) Provisional application No. 60/734,081, filed on Nov. 7, 2005.

(51) Int. Cl. B41J 35/16

(52) U.S. Cl. 347/172

(57) ABSTRACT

A thermal printing head having a two-dimensional array of resistive heating elements, and a method of printing using such a thermal printing head. The resistive heating elements in different rows of such elements may differ in dimensions, resistance, or other physical properties. The thermal printing head may be used to address a direct thermal medium containing more than one color-forming composition, in which different color-forming compositions produce different colors when heated.

### CROSS-REFERENCES TO RELATED APPLICATIONS

This application claims the benefit of prior provisional patent application Ser. No. 60/734,081, filed Nov. 7, 2005.

This application is related to the following commonly assigned, United States patent applications and patents, the entire disclosures of which are hereby incorporated by reference herein in their entirety:

U.S. Pat. No. 6,801,233 B2;

U.S. Pat. No. 6,906,735 B2;

U.S. Pat. No. 6,951,952 B2;

U.S. Pat. No. 7,008,759 B2;

U.S. patent application Ser. No. 10/806,749, filed Mar. 23, 2004, which is a division of U.S. Pat. No. 6,801,233 B2;

U.S. patent application Ser. No. 10/374,847, filed Feb. 25, 2003;

U.S. patent application Ser. No. 10/789,648, filed Feb. 27, 2004;

U.S. patent application Ser. No. 10/789,566, filed Feb. 27, 2004;

U.S. patent application Ser. No. 10/789,600, filed Feb. 27, 2004;

U.S. patent application Ser. No. 11/159,880, filed Jun. 23, 2005;

U.S. patent application Ser. No. 11/400,734, filed Apr. 6, 2006;

U.S. patent application Ser. No. 11/400,735, filed Apr. 6, 2006; and

U.S. patent application Ser. No. 60/734,081, filed Sep. 20, 2006.

### FIELD OF THE INVENTION

The present invention relates generally to thermal printing devices. More specifically, the present invention relates to a thermal printing head having a two-dimensional array of resistive heating elements, and a method of printing using such a thermal printing head.

### DESCRIPTION OF RELATED ART

Thermal printing heads used in imaging applications typically comprise a row of resistive heating elements extending across the entire width of the image to be printed. An image is formed by heating an imaging member while it is being transported in a direction perpendicular to the row of resistive heating elements on the print head. Pulses of heat are provided by supplying electrical current to the resistive heating elements. Each resistive heating element is individually addressable, such that any combination of pixels may be printed in a given line of the image. In some embodiments, the width of the thermal printing head may be less than the width of the image. In such cases the thermal printing head may be translated relative to the thermal imaging member in order to address the entire width of the image, or else more than one thermal printing head may be used.

Although the majority of commercially-available thermal printing heads have only a single row of resistive heating elements, thermal printing heads having a two-dimensional array of resistive heating elements (i.e., more than one line of resistive heating elements) are known in the art. For example, Japanese Patent Nos. JP-7290744 and JP-63084948 disclose thermal printing heads having two rows of resistive heating elements, each row being separately addressable. Japanese Patent No. JP-6206324 discloses a two-dimensional matrix of resistive heating elements comprising a plane of resistive heating elements located between a plane of row electrodes and a plane of column electrodes. A similar arrangement is disclosed in Japanese Patent No. JP-4358849. Japanese Patent No. JP-6278295 discloses a thermal printing head having two rows of resistive heating elements, in which the substrates for each row of resistive heating elements are not parallel to one another. Japanese Patent No. JP-9314881 discloses a thermal printing head having a single row of resistive heating elements in which the resistances of each resistive heating element in the row are not the same.

### SUMMARY OF THE INVENTION

One object of the present invention is to provide a method for forming an image by heating a thermal imaging member with a single thermal printing head having more than one row of resistive heating elements, in which a first color is addressed by a row of resistive heating elements that is not used to address a second color.

Another object is to provide a method for forming an image by heating a thermal imaging member with a thermal printing head having more than one row of resistive heating elements, in which the method of supplying electrical power to a first row of resistive heating elements is not the same as the method of supplying electrical power to a second row of resistive heating elements.

Yet another object of the present invention is to provide a printing head comprising more than one row of resistive heating elements, in which the number of resistive heating elements per unit length in a first and second row of resistive heating elements is the same, and the resistance of any one resistive heating element in a first row is substantially different from the resistance of the corresponding resistive heating element in a second row.

Yet another object of the present invention is to provide a printing head comprising more than one row of resistive heating elements, in which the average resistance of the resistive heating elements in a first row is different from the average resistance of the resistive heating elements in a second row by a factor of at least about 1.5.

Yet another object is to provide a printing head comprising more than one row of resistive heating elements in which one row of resistive heating elements comprises elements that are a different shape from the resistive heating elements in a second row.

Yet another object of the present invention is to provide a printing head comprising more than one row of resistive heating elements, in which the number of resistive heating elements per unit length across a first row is substantially different from the number of resistive heating elements per unit length across a second row.

### BRIEF DESCRIPTION OF THE DRAWINGS

Additional objects, features, and advantages of the present invention will become apparent from the following detailed description of the preferred embodiments of the invention in conjunction with the accompanying drawings where like reference numerals indicate like features, in which:

FIG. 1 is a schematic diagram of a multicolored direct thermal imaging member;

FIG. 2 is a diagram showing the temperatures and times used in addressing a multicolored direct thermal imaging member;

FIG. 3 is a schematic, cross-sectional view of a typical thermal printing head;

FIG. 4 is a schematic drawing of a pattern of resistive heating elements of a thermal printing head of the present invention;

FIGS. 5-8 are schematic drawings of prior art resistive heating elements; and

FIGS. 9-23 are schematic drawings of thermal printing heads according to the present invention. None of FIGS. 1-23 is drawn to scale.

Although electrical switches are indicated in the diagrams with the conventional symbol for mechanical switches, it will be understood by those skilled in the art that they may be any type of switching device, including transistors, FET's or other semiconductor devices.

### DETAILED DESCRIPTION OF PREFERRED EMBODIMENTS

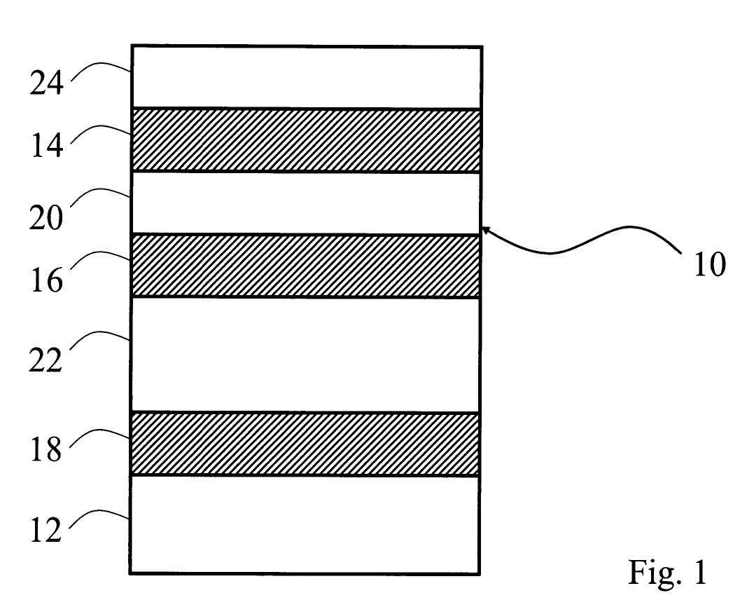

Thermal printing heads are typically used to address imaging members of two general types: 1) those that rely on thermal transfer, in which heat is used to move a colorant from a donor to a receiver sheet, and 2) direct thermal systems, in which heat is used to convert a colorless composition arranged on a substrate into a colored form. The direct thermal method requires only a single sheet, and is the preferred approach from the standpoint of system cost and complexity. U.S. Pat. No. 6,801,233 B2 describes a single-sheet, direct thermal imaging member with which any color may be rendered simply by heating, preferably in a single printing pass with a single print head. The imaging member is stable before and after printing, and insensitive to normal room light. As shown in FIG. 1, thermal imaging members such as that described in U.S. Pat. No. 6,801,233 B2 may comprise three color-forming layers, each of which is initially colorless and produces an image in one of the three subtractive primary colors (cyan, magenta and yellow) when heated.

Referring now to FIG. 1, there is seen a thermal imaging member 10 that includes a substrate 12, that can be transparent, absorptive, or reflective, and three image-forming layers 14, 16, and 18, which may form yellow, magenta and cyan, respectively, spacer layers 20 and 22, and an optional overcoat layer 24.

Each image-forming layer can change color, e.g., from initially colorless to colored, where it is heated to a particular temperature referred to herein as its activating temperature. Spacer layer 20 is preferably thinner than spacer layer 22, provided that the materials comprising both layers have substantially the same thermal diffusivity. The function of the spacer layers is to control thermal diffusion within the imaging member 10.

All the layers disposed on the substrate 12 are substantially transparent before color formation. When the substrate 12 is reflective (e.g., white), the colored image formed on imaging member 10 is viewed through the overcoat 24 against the reflecting background provided by the substrate 12. The transparency of the layers disposed on the substrate ensures that combinations of the colors printed in each of the image-forming layers may be viewed.

Each of the image-forming layers 14, 16 and 18 is independently addressed by application of heat using a thermal printing head in contact with the topmost layer of the member, usually optional overcoat layer 24 in the member illustrated in FIG. 1. The activating temperature (Ta₁) of the first image-forming layer 14 is greater than the activating temperature (Ta₂) of the second image-forming layer 16, which in turn is greater than the activating temperature (Ta₃) of the third image-forming layer 18. Delays in heating of image-forming layers at greater distances from the thermal printing head are provided by the time required for heat to diffuse to these layers through the spacer layers. Such delays in heating permit the image-forming layers closer to the thermal printing head to be heated to above their activating temperatures without activating the image-forming layer or layers below them even though these activating temperatures can be substantially higher than the activating temperatures for the lower image-forming layers (those that are farther away from the thermal print head). Thus, when addressing the uppermost image-forming layer 14 the thermal printing head is heated to a relatively high temperature, but for a short time, such that insufficient heat is transferred to the other image-forming layers of the imaging member to provide image information to either of image-forming layers 16 and 18. The activating temperatures selected for the image-forming layers are generally in the range of about 90° C. to about 300° C. The activating temperature (Ta₃) of the third image-forming layer 18 is preferably as low as possible consistent with thermal stability of the imaging member during shipment and storage and preferably is about 100° C. The activating temperature (Ta₁) of the first image-forming layer 14 is preferably as low as possible consistent with allowing the activation of the second and third image-forming layers 16 and 18 by heating through this layer without activating it according to the method of the invention, and preferably is about 200° C. or more. The activating temperature (Ta₂) of the second image-forming layer is between Ta₁ and Ta₃ and is preferably between about 140° C. and about 180° C.

The heating of the lower image-forming layers, i.e., those closer to the substrate 12, is accomplished by maintaining the thermal printing head at temperatures such that the upper image-forming layer(s) remain below their activating temperatures for sufficient periods of time to allow heat to diffuse through them to reach the lower image-forming layer(s). In this way, no image information is provided in the upper image-forming layer(s) when the lower image-forming layer(s) are being imaged. The heating of the image-forming layers according to the method of the invention may be accomplished by one or more than one pass of a single thermal printing head, or by one or more than one pass of each of more than one thermal printing head, as is described in detail below.

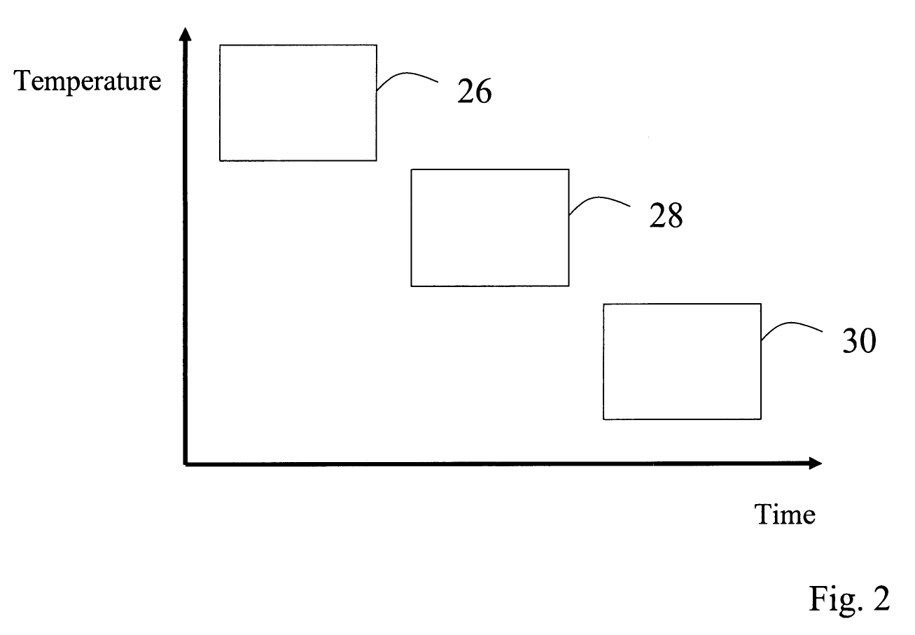

Control of two independent variables available in a thermal printer, namely, the power that is supplied to the resistive heating elements of the thermal print head, and the length of time during which that power is supplied, allow the independent addressing of each of the color-forming layers of an imaging member such as that shown in FIG. 1. The higher the power that is supplied to a resistive heating element, the higher will be the temperature of that element and therefore the higher will be the temperature of the surface of the medium with which it is in contact. Independent addressing of colors can consequently be achieved as shown schematically in FIG. 2.

FIG. 2 shows, qualitatively, the temperatures and times of heating required to address image-forming layers 14, 16 and 18 of thermal imaging member 10. The axes of the graph in FIG. 2 show the heating time and the temperature of the resistive heating element of the thermal printing head that is in thermal contact with the surface of the thermal imaging member. Region 26 (relatively high resistive heating element temperature and relatively short heating time) provides imaging of image-forming layer 14; region 28 (intermediate resistive heating element temperature and intermediate heating time) provides imaging of image-forming layer 16; and region 30 (relatively low resistive heating element temperature and relatively long heating time) provides imaging of image-forming layer 18. As can be seen in FIG. 2, it is possible to follow paths in the time/temperature plane starting from the origin (i.e., ambient temperature, zero heating time) that lead to regions in which each color is formed without encroaching on regions in which another color is formed.

Although FIG. 2 illustrates the addressing of three colors, provided that the range of times and temperatures is sufficiently large, any number of colors can, in principle, be independently addressed according to such a scheme.

The precise shape of the printing regions in practice will not, of course, be rectangular as shown in FIG. 2, but will depend upon the detailed physics of the particular thermal imaging member and printing apparatus.

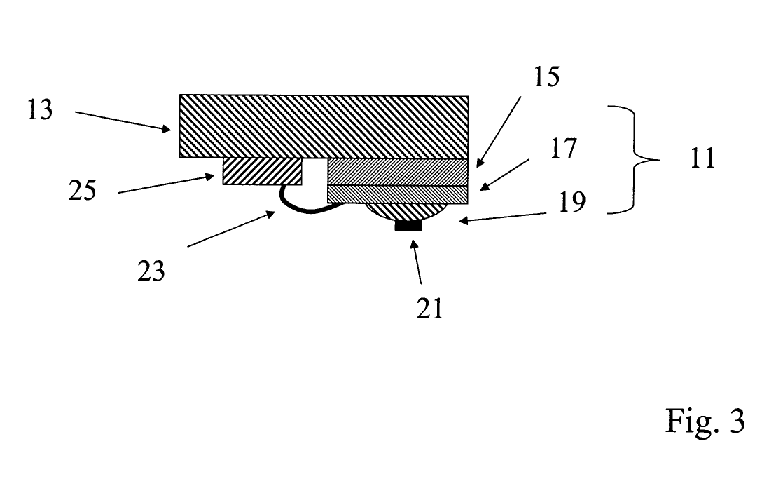

Referring now to FIG. 3, there is seen a typical thermal printing head 11, illustrated in a cross-sectional view. The printing head comprises a support 13 that carries the driving circuitry 25 and an assembly that bears the heating elements. This assembly may be constructed as follows. The heating elements 21 may be carried by a glaze layer 17 deposited on a ceramic substrate 15. Ceramic substrate 15 is in contact with support 13. Shown in the figure is an optional raised “glaze bump” 19 on which the heating elements 21 are located, but they may also be carried by the surface of glaze layer 17 when glaze bump 19 is absent. Wires 23 provide electrical contact between the heating elements 21 and the driving circuitry 25.

The support 13 provides mechanical strength to the printing head so that it may be easily affixed to the chassis of the printer and biased against the thermal imaging member. Support 13 may also function as a heat sink, and is commonly made of a material of high thermal conductivity, such as aluminum. Support 15 may be provided with cooling fins for air cooling, or channels for liquid cooling, as described above. The temperature of support 13 may be monitored (by means, for example, of a thermistor), and knowledge of this temperature may be used to adjust the energy that is provided to the heating elements for optimal imaging, as is known in the art and described, for example, in U.S. Pat. No. 6,819,347.

Because conventional direct thermal or thermal transfer imaging members require heating to form only a single color, design of thermal printing heads for addressing such imaging members has remained fairly straightforward. The motivation for incorporation of more than one row of resistive heating elements in prior art thermal printing heads has been, for example, to increase the resolution of the thermal printing head or to increase the speed of printing by addressing more than one line at a time.

As described above, however, in addressing a multicolored direct thermal imaging medium of the type shown in FIG. 1, the power that is supplied to the resistive heating elements of the thermal printing head, and the length of time during which that power is supplied, are different for each color. If the power is to be different for each color, but a single row of resistive heating elements is to be used, then typically either the voltage supplied to the resistive heating elements is changed when printing each color or, in the case where the voltage is constant, the average power supplied for printing each color is adjusted by pulsing with different duty cycles. Such pulsing must be done at a rate fast enough that the individual pulses are not resolvable as dots printed onto the imaging member. Such a pulsing scheme is described in U.S. Pat. No. 6,801,233 B2. In practice, the need for such very rapid pulsing may require complex and expensive electronic control.

Another difficulty arises when addressing more than one color in a multicolor direct thermal imaging member in a single pass of a thermal printing head having only a single row of resistive heating elements. In such a case, the time available for printing a given line must be shared between the different colors (i.e., all of the different color-forming layers of the thermal imaging member must be addressable within the time available for printing a single line). In practice, this means that printing of at least one color may be less than optimal. In particular, when printing the color with the highest activation temperature and the color with the lowest activation temperature together, ideally none of any color having an intermediate activation temperature should be printed. When these two colors are printed almost simultaneously within a single line time, this may be difficult to achieve. It becomes much easier to avoid undesired coloration of an intermediate-temperature color if there is a delay between printing the highest-temperature color and printing the lowest-temperature color. Such a delay may be achieved by a spatial offset between rows of resistive heating elements of a thermal printing head having more than one row of such elements.

Therefore, one preferred method of the present invention is addressing a multicolored direct thermal imaging member with a single thermal printing head in a single pass, in which a first color is addressed by a row of resistive heating elements that is not used to address a second color. For example, a first row could be used to address the highest-temperature color, and a second row could be used to address the lowest-temperature color. The intermediate-temperature color or colors could be addressed by either row, or else by yet another row of resistive heating elements.

When the thermal printing head contains more than one row of resistive heating elements, the addressing of more than one color by variation of power and time of heating may become more straightforward than if the printing head has only a single row of resistive heating elements. For example, a higher voltage may be applied to a first row of resistive heating elements than to a second row. The first row will provide a higher power than the second row, and may be used to form an image in a color requiring high power and short time. The second row may be used to form an image in the color requiring a low power and a long time.

More generally, an object of the present invention is to provide a method for forming an image by heating a thermal imaging member with a thermal printing head having more than one row of resistive heating elements, in which the method of supplying electrical power to a first row of resistive heating elements is not the same as the method of supplying electrical power to a second row of resistive heating elements. As mentioned above, a different voltage may be applied to a first than to a second row of resistive heating elements. Likewise, a different duty cycle of pulsing may be applied when printing with a first row of resistive heating elements than when printing with a second row. It is also possible that a different dot screening pattern might be used for printing with a first row of resistive heating elements than for printing with a second row. In addition, different dot placement (i.e., “phasing” as described below) may be used for printing with a first row of resistive heating elements than for printing with a second row.

The purpose of phasing is to minimize the peak power that must be supplied to a row of resistive heating elements (i.e., to provide load leveling). When the imaging is carried out in a single pass of the thermal printing head, the speed of transport of the imaging member past a first and a second row of resistive heating elements is the same. However, as mentioned above, the time of heating required when printing a color requiring a high power is shorter than the time required when printing a color requiring a relatively low power. In the case where a first row of resistive heating elements is used to form an image in a color-forming layer of the thermal imaging member requiring relatively high power, and a second row of resistive heating elements is used to form an image in a color-forming layer requiring the relatively low power, the time during which power must be supplied to a resistive heating element in the first row will typically be shorter than the time during which power must be supplied to the corresponding resistive heating element in the second row. To maintain a low peak power requirement when printing with all the elements in the first row, it may be preferred not to address every element in that row at the same time. The ratio of the time required for heating of an element in the second row to the time required for heating of an element in the first row (n, say) gives the maximum number of groups into which the resistive heating elements in the first row may be divided such that each resistive heating element in a group is heated simultaneously, no element in one group is heated while any element in another group is being heated, and all elements in the first row are heated during the time required for printing using the second row. Since the heating of each group of elements in the first row is temporally offset from the heating of the other groups, the maximum number of “phases” of the heating cycle when addressing the entire first row is “n”, and this method of addressing of the line of resistive heating elements is known as “phasing”. The peak power for printing with the first row of resistive heating elements is not given by the peak power for one element in the row multiplied by the total number of elements in that row, but rather is given by this quantity divided by “n”.

Thus, one preferred method of the present invention comprises heating a multicolor direct thermal imaging member with a thermal printing head having more than one row of resistive heating elements, in which the phasing of the addressing of a first row of resistive heating elements is not the same as the phasing of the addressing of a second row of resistive heating elements.

Another object of the present invention is to provide a method for forming an image by heating a thermal imaging member with a thermal printing head having more than one row of resistive heating elements, in which a correction(s) that is/are applied to the image printed by one row of resistive heating elements is/are different from a correction(s) that is/are applied to the image printed by a second row of resistive heating elements.

In the practice of the present invention, it is preferred that the printing pulses supplied by the thermal printing head be adjusted so as to compensate for the residual heat in the printing head itself and in the thermal imaging member that results from the printing of preceding (and neighboring) pixels in the image. Such thermal history compensation may be carried out as described in U.S. Pat. No. 6,819,347 B2. It is usual that the thermal history compensation required for a first row of resistive heating elements in a thermal printing head having more than one row of resistive heating elements will be different from the thermal history compensation required for a second row. For example, one row may encounter the thermal imaging member when the member is at ambient temperature, but a second row may encounter the thermal imaging member shortly after the member has been heated by the first row.

Another correction that may be different for one row of resistive heating elements than for another is a voltage correction such as that described in U.S. Pat. No. 6,661,443 B2. This correction ensures that the same amount of thermal energy is provided by a resistive heating element in a particular row intended to produce a particular color regardless of the number of resistive heating elements in that row that are active at the time of printing.

Yet another correction that may be different for one row of resistive heating elements than for another is the correction for streaks in the image in the direction of transport of the imaging member. Such streaks may arise from non-uniformities in the thermal printing head, such that each resistive heating element does not provide exactly the same amount of thermal energy to the imaging member even though all resistive heating elements are intended to do so. There are many possible sources of such non-uniformity, for example, non-uniform resistance of the resistive heating elements, or lack of uniform thickness of any glaze or protective layers comprising the thermal printing head.

Using a thermal printing head having more than one row of resistive heating elements provides additional flexibility in controlling the power supplied in order to select a particular color as is required in the printing methods of the present invention. For example, the resistance of each resistive heating element in a row that addresses one color may be different from the resistance of each resistive heating element in a row that addresses a second color. Neither the voltage nor the duty cycle of pulsing need be different for addressing of each color (although in practice some adjustment may be needed) since the power dissipated in the resistive heating elements will be controlled by their resistance (and equal to Vˆ2/R).

One preferred printing head of the present invention comprises more than one row of resistive heating elements, in which the average resistance of the resistive heating elements in a first row is different from the average resistance of the resistive heating elements in a second row by a factor of at least about 1.5.

A particularly preferred printing head of the present invention comprises more than one row of resistive heating elements, in which the resistance of each of the resistive heating elements in a particular row is substantially the same, and the resistance of the each of the resistive heating elements in a first row is substantially different from the resistance of each of the resistive heating elements in a second row.

It is not necessary that the resistance of each resistive heating element in a particular row be the same, although in practice it is certainly easier to manufacture thermal printing heads of this type. In another type of preferred thermal printing head of the present invention comprising more than one row of heating elements, the number of resistive heating elements per unit length across a first and second row of resistive heating elements is the same, and the resistance of any one resistive heating element in a first row is substantially different from the resistance of the corresponding resistive heating element in a second row.

As mentioned above, control of the heating time for a particular color-forming layer is required as well as control of the power supplied. The longer a resistive heating element extends in the direction of transport of the imaging member, the longer can be the heating time for a given rate of transport of the imaging member. For a color-forming layer that is addressed at a low temperature and for a long time, therefore, a long resistive heating element in the transport direction may be preferred. For a color-forming layer that is addressed at a high temperature (i.e., high power) for a short time, on the other hand, a resistive heating element with a large area may require an impracticably large current to be supplied. It may be preferred for this layer to be addressed with a shorter resistive heating element and more frequent heating pulses. A preferred thermal printing head of the present invention comprises more than one row of resistive heating elements, in which one row of resistive heating elements comprises elements that are of a different shape than the resistive heating elements in a second row.

A particularly preferred thermal printing head of the present invention comprises more than one row of resistive heating elements, in which a first row of resistive heating elements comprises elements that are longer, as measured in the direction perpendicular to the row, than the resistive heating elements in a second row.

Another object of the present invention is to provide a printing head comprising more than one row of resistive heating elements, in which the number of resistive heating elements per unit length across a first row is substantially different from the number of resistive heating elements per unit length across a second row. Such a second row might, for example, be used to print an image in black text. In an extreme case, one row may comprise only a single resistive heating element, and this resistive heating element may be used to provide pre-heating or post-heating of the thermal imaging member. Alternatively, such a single element may be used to provide a “background color” to an image that is printed by a multi-element, second row. Using such a printing head in combination with a thermal imaging member 10, differently colored labels bearing monochrome text would readily be printed.

As described in U.S. patent application Ser. Nos. 11/400,735 and 11/400,734, both filed on Apr. 6, 2006, the amount of heat that must be supplied to a multicolored direct thermal imaging member may be significantly affected by the temperature of the thermal imaging member at the time of heating. Adjustment of the starting temperature of a particular color-forming layer (hereinafter referred to as the “baseline temperature” of that layer) may be achieved through pre-heating of the thermal imaging member. The color-forming layers with the lowest activation temperatures are affected differently by preheating than color-forming layers with higher activation temperatures. It may be preferred to preheat the medium before printing the color-forming layers with low activation temperatures but not before printing the color-forming layers with higher activation temperatures. When a thermal printing head with more than one row of resistive heating elements is used to form an image in a multicolored direct thermal imaging member, it may therefore be advantageous if there also is provided, in between the two rows of resistive heating elements, a single resistive heating element extending across the entire width of the thermal printing head that is used to pre-heat the thermal imaging member.

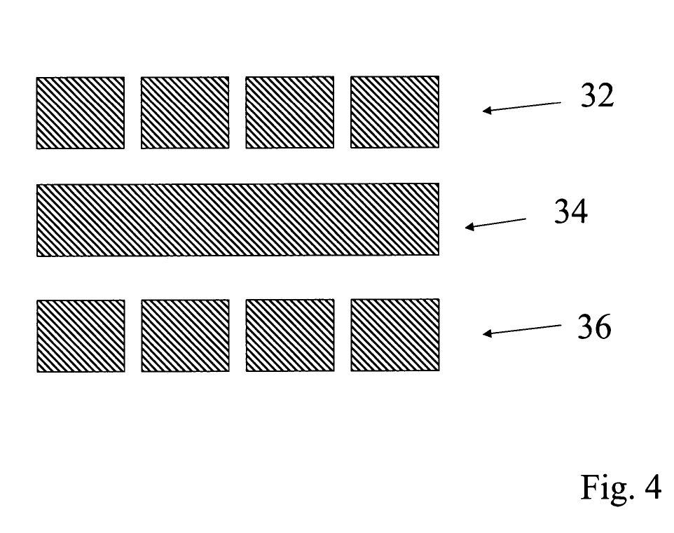

FIG. 4 shows in schematic form the pattern of resistive heating elements of such a printing head. A first row of resistive heating elements 32 is separated from a second row of resistive heating elements 36 by a single element 34 that may be used to heat the thermal imaging medium after an image is formed with row 32 but before an image is formed with row 36.

The matter of addressing more than one row of individual resistive heating elements may be solved in a variety of ways, some of which are known in the art. For example, the methods of Japanese Patent Nos. JP-7290744, JP-63084948 and JP-6206324 discussed above may be employed. There are also some methods for addressing more than one row of resistive heating elements that have not hitherto been described that may be advantageous in the practice of the present invention.

In ideal addressing of more than one row of resistive heating elements, each resistive heating element in each row would be independently addressable at the same time. In the current state of manufacturing art, each switchable electrode must be connected to driving circuitry, and this connection is typically made via a wire bond. It is preferred that all wire bonds be made on the same side of the array of resistive heating elements, since the cost of assembly is higher when wire bonds have to be made on both sides of the array. Finally, it is preferred that the electrodes all be located in the same plane, or on the same surface. It is possible that multiple planes of electrodes or connectors may be employed, as discussed below, but this adds to the cost of the thermal printing head.

A brief discussion of prior art methods of addressing a single row of resistive heating elements will now be given, since each method has geometrical consequences that affect how electrical connections may be made in a two-dimensional array of resistive heating elements.

A typical resistive heating element used in the art is made by depositing a thin layer of a resistive material between two opposing electrodes made of a highly conductive material. The process of deposition may be sputtering in a vacuum (producing what is known in the art as a “thin film” resistive heating element) or a liquid deposition process (producing what is known in the art as a “thick film” resistive heating element). The precision of the former process is generally greater than that of the latter. Either process may be used to fabricate thermal printing heads of the present invention. Other approaches may also be employed. It is generally preferred that the current passing through the resistive heating element travel substantially in the plane of the substrate on which the resistive heating element is deposited. There are thus two dimensions in which the current may be designed to travel: substantially parallel to the row of resistive heating elements, and substantially perpendicular to the row. Corresponding to these two directions, the opposing electrodes are arranged either substantially perpendicular or substantially parallel, respectively, to the row of resistive heating elements.

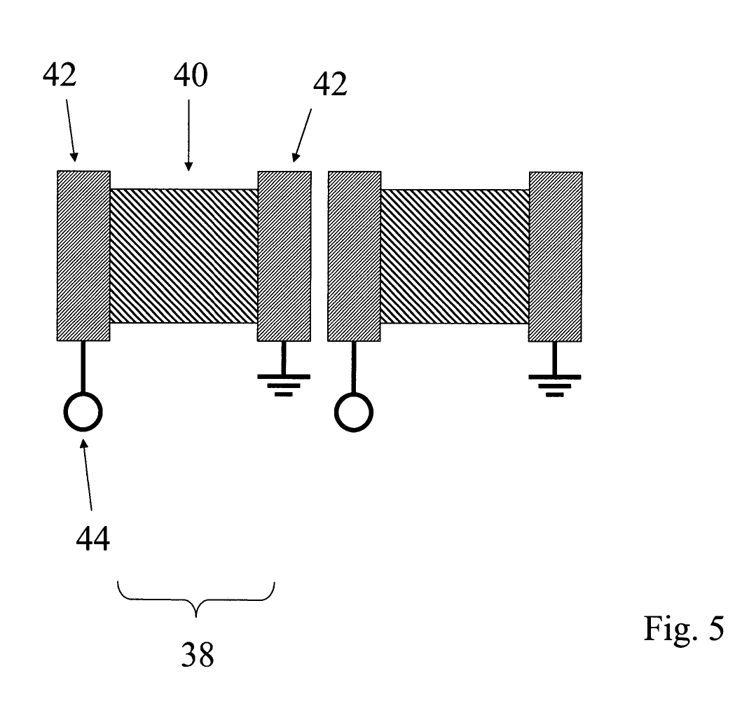

FIG. 5 shows two resistive heating elements of a row of such elements in a prior art thermal printing head. In this case, the electrodes 42 are arranged such that current travels in resistive heating element 40 in a direction parallel to the row from voltage source 44 to the ground. In this arrangement the voltage source and the ground can be connected to the same side of the row of resistive heating elements without the need for a connection that crosses either between the resistive heating elements of the row or around the end of the row. Combination 38 comprises one addressable pixel.

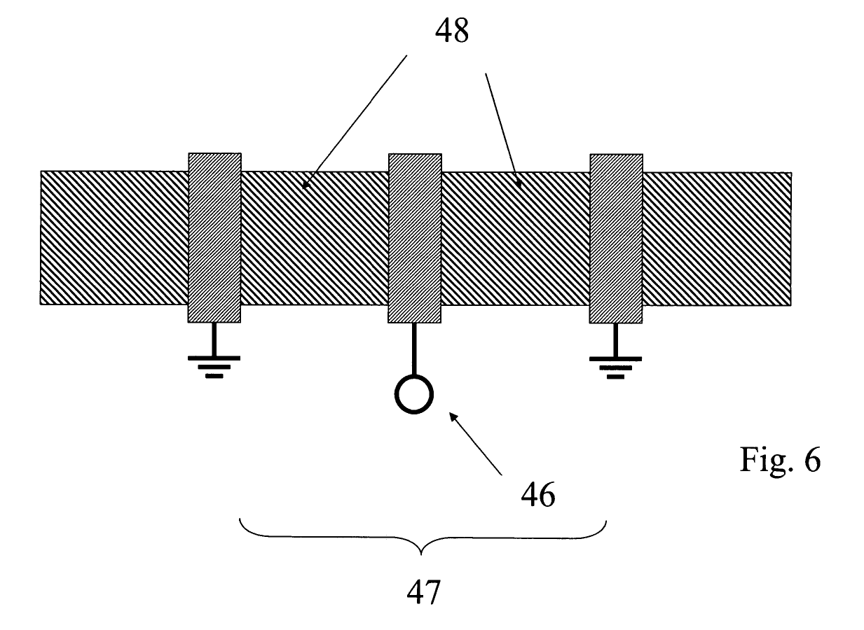

In practice, for reasons of ease of manufacturing, a design such as that shown in FIG. 6 is often preferred to that shown in FIG. 5. In this case, each addressable pixel 47 shares a ground electrode with the pixels on either side. When a potential is applied to the central electrode 46, current flows to either side through resistive material 48 in a direction parallel to the row of resistive heating elements, generating two heated regions per addressable pixel.

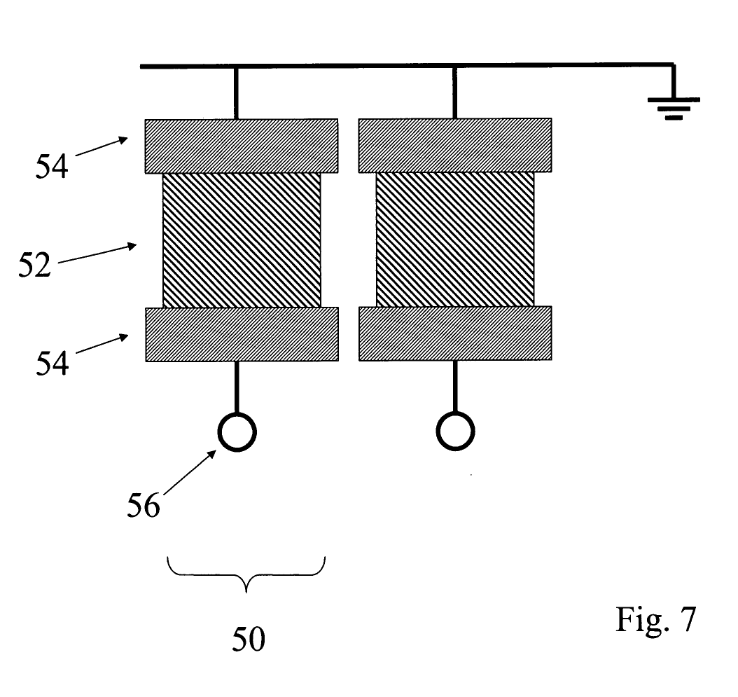

FIG. 7 shows two resistive heating elements of a row of such elements in another type of prior art thermal printing head. In this case, the electrodes 54 are arranged such that current travels in resistive heating element 52 in a direction perpendicular to the row from voltage source 56 to the ground. In this arrangement the voltage source and the ground cannot be connected to the same side of the row of resistive heating elements without the need for a connection that crosses either between the resistive heating elements of the row or around the end of the row. In the case that all addressable pixels have a common ground, this may wrap around the end of the row to provide a connection on the same side of the row as the source connections. Combination 50 comprises one addressable pixel.

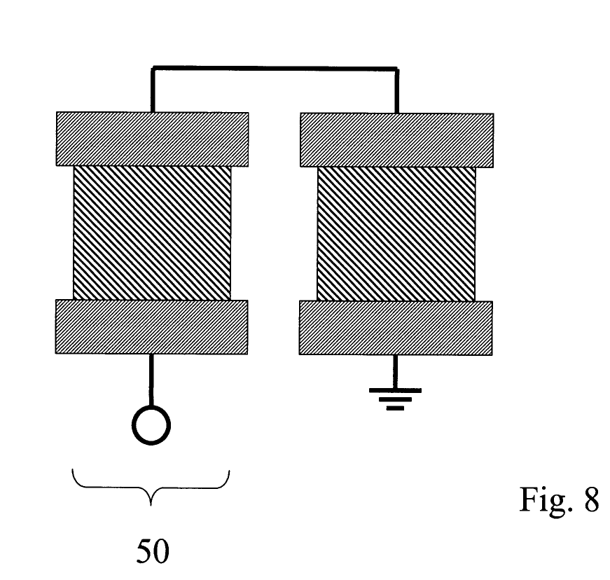

FIG. 8 shows a prior art arrangement of resistive heating elements in a row of such elements in which pairs of elements are connected together. In this fashion, the source and ground connections may be made on the same side of the row, but the addressable resolution is half that of the printed dots (i.e., dots are printed in pairs). To summarize, in the prior art methods of addressing a single row of resistive heating elements, electrodes are arranged either to produce current flow substantially parallel to the row, in which case the source and ground connections may be made on the same side of the row, or else to produce current flow substantially perpendicular to the row, in which case the source and ground connections of a particular resistive heating element are on opposite sides of the row.

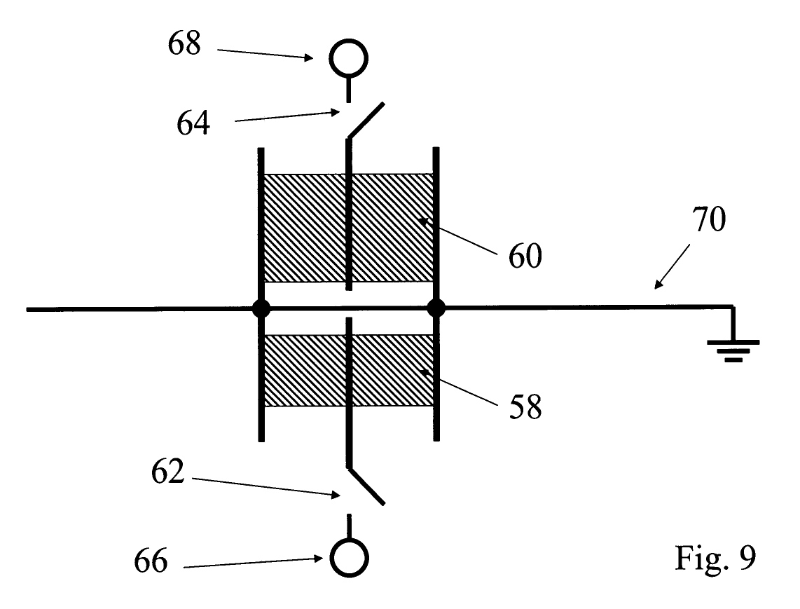

FIG. 9 shows a design for the resistive heating elements of a thermal printing head of the present invention having two rows of resistive heating elements 58 and 60. In each row, the electrodes addressing each resistive heating element are perpendicular to the row. It will be apparent to one of skill in the art that a similar design in which the electrodes addressing each resistive element in each row are parallel to the row, with a common ground between the rows, may be constructed. Unless more than one plane of electrodes is employed (see later discussion) connections 66 and 68 need to be made on opposite sides of the array. Each element of either row is individually addressable at the same time through switches 62 and 64. When a switch is closed, current passes through the resistive heating element to common ground 70 that services all the electrodes in the row. Although the switches are shown as being located between the connections and the electrodes (in this and subsequent figures), this is for convenience only. In practice, the connections 66 and 68 may be used to connect the electrodes to external switching circuitry.

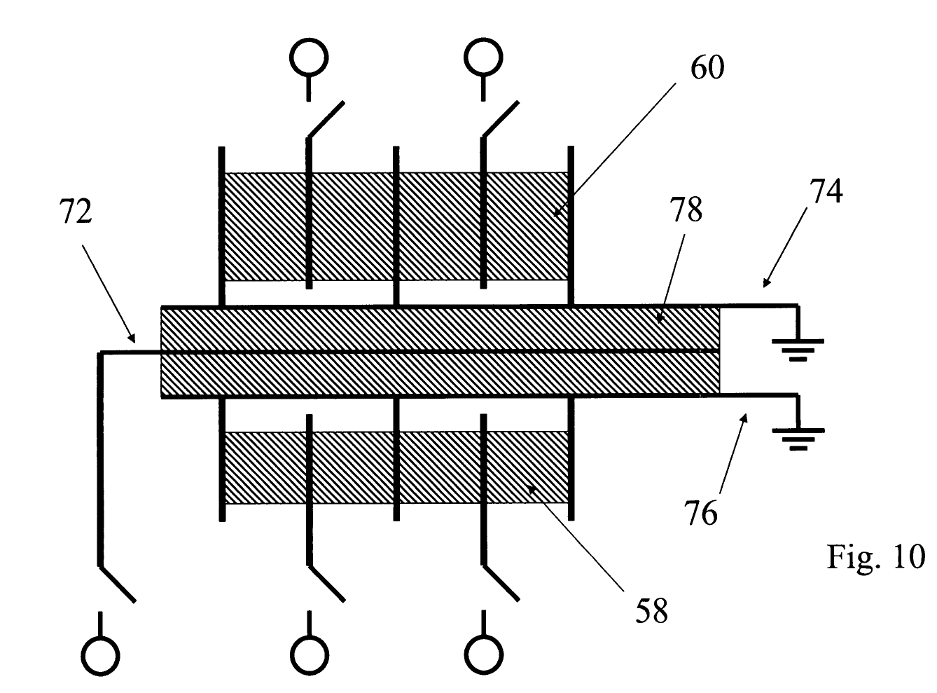

FIG. 10 shows the same essential addressing scheme as FIG. 9. In FIG. 10 there is also shown a resistive heating element 78 that extends across the whole width of the thermal printing head. Resistive heating element 78 might be used to heat the medium after forming an image with resistive elements 58 but before forming an image with resistive heating elements 60, as discussed above with reference to FIG. 4.

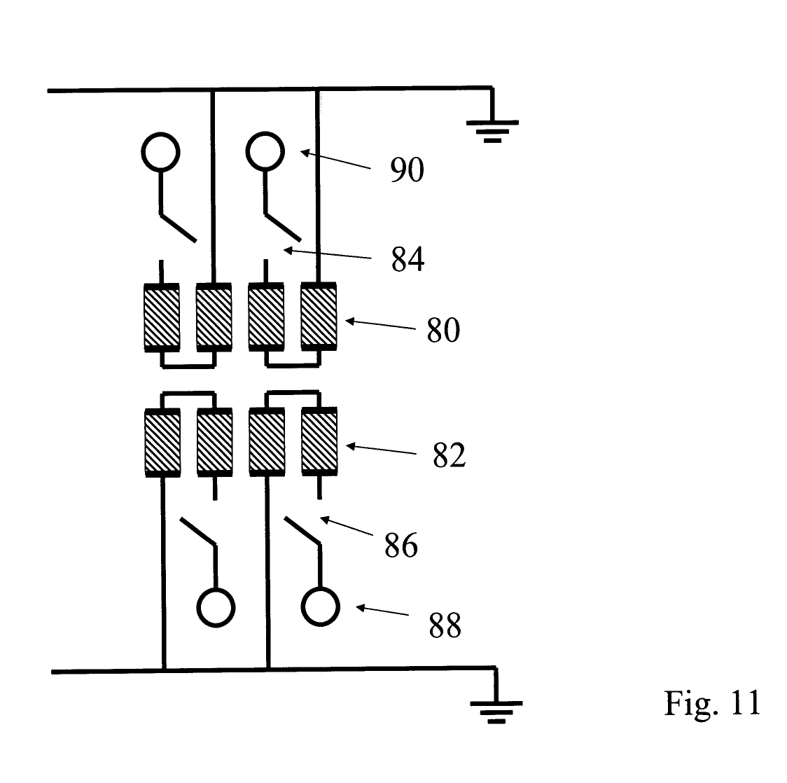

FIG. 11 shows a design for the resistive heating elements of a thermal printing head of the present invention having two rows of resistive heating elements 80 and 82. In each row, the electrodes addressing each resistive heating element are parallel to the row, and resistive heating elements are arranged in pairs as discussed above with reference to FIG. 8. Unless more than one plane of electrodes is employed (see later discussion) connections 88 and 90 need to be made on opposite sides of the array. Each element pair of either row is individually addressable at the same time through switches 84 and 86. When a switch is closed, current passes through two resistive heating elements. It will be apparent to one of skill in the art that a single resistive heating element, similar to that shown in FIG. 10, might be inserted between the two rows of resistive heating elements in a design such as that shown in FIG. 11.

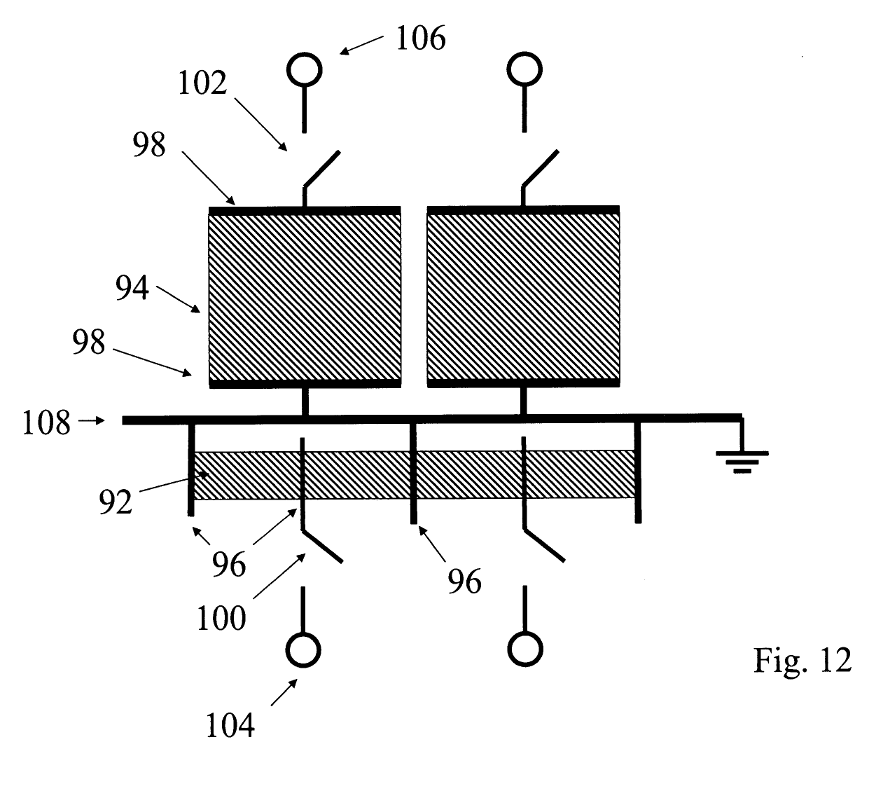

FIG. 12 shows a design for the resistive heating elements of a thermal printing head of the present invention having two rows of resistive heating elements 92 and 94. In one row, the electrodes 96 addressing each resistive heating element are perpendicular to the row, while in the second row the electrodes 98 addressing each resistive heating element are parallel to the row. Unless more than one plane of electrodes is employed (see later discussion) connections 104 and 106 need to be made on both sides of the array. Each element of either row is individually addressable at the same time through switches 100 and 102. When a switch is closed, current passes through the resistive heating element to common ground 108. It will be apparent to one of skill in the art that a single resistive heating element, similar to that shown in FIG. 10, might be inserted between the two rows of resistive heating elements in a design such as that shown in FIG. 12.

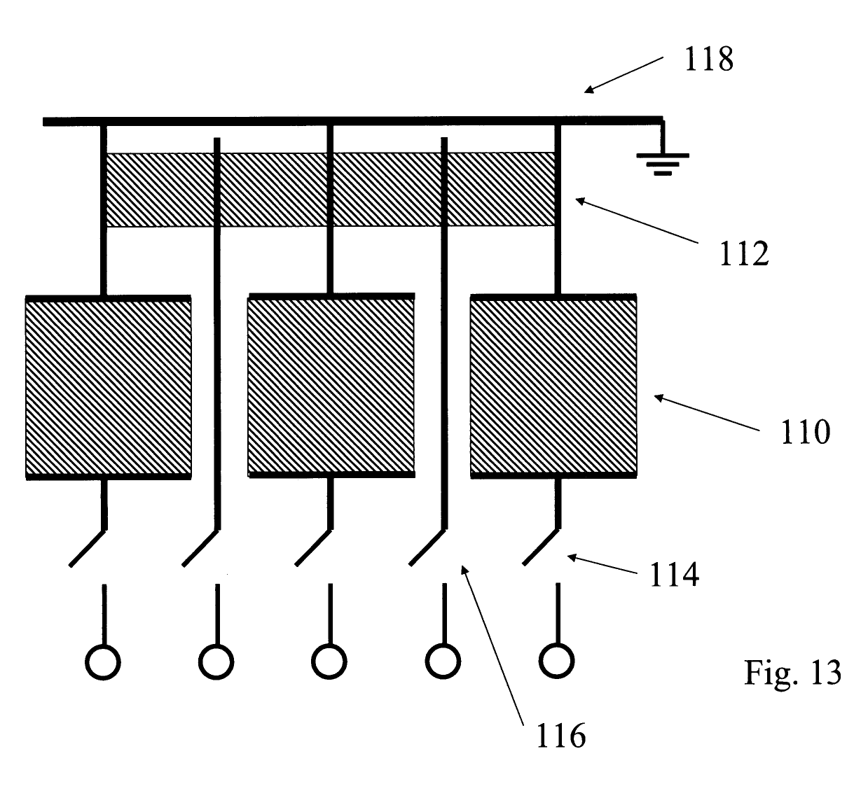

FIG. 13 shows a design for the resistive heating elements of a thermal printing head of the present invention having two rows of resistive heating elements 110 and 112 in which all switching connections are on the same side of the array and all the electrodes are located in the same plane. In one row, the electrodes addressing each resistive heating element are perpendicular to the row, while in the second row the electrodes addressing each resistive heating element are parallel to the row. Each element of either row is individually addressable at the same time through switches 114 and 116. When a switch is closed, current passes through the resistive heating element to common ground 118.

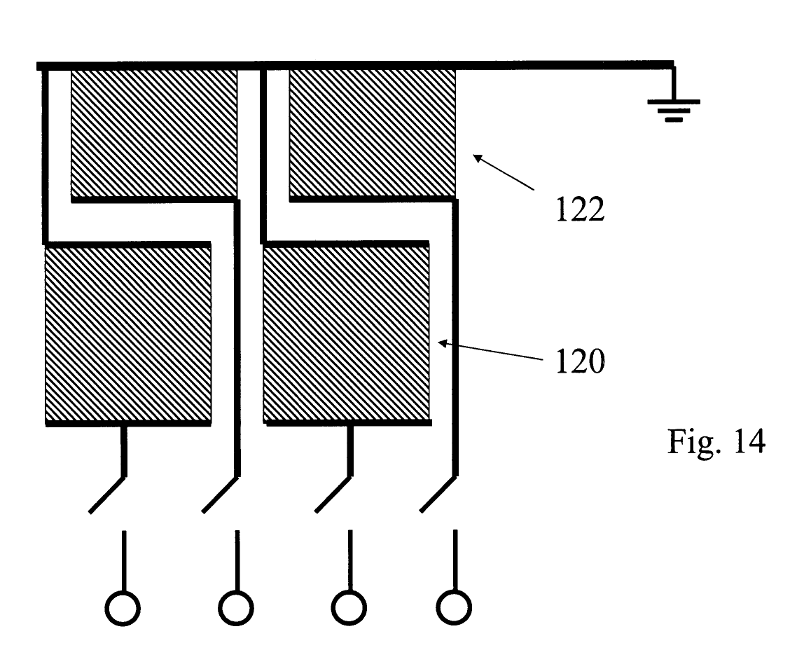

FIG. 14 shows another design for the resistive heating elements of a thermal printing head of the present invention having two rows of resistive heating elements 120 and 122 in which all switching connections are on the same side of the array and all the electrodes are located in the same plane. In both rows, the electrodes addressing each resistive heating element are parallel to the row. Similarly to the design shown in FIG. 12, each element of either row is individually addressable at the same time. As mentioned above, in the designs illustrated in FIGS. 9-12, switching connections might be made on the same side of the array if more than one plane of electrodes is employed.

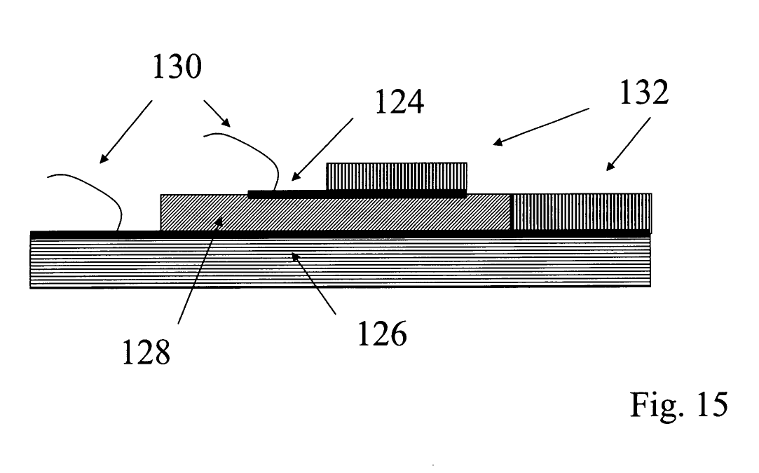

FIG. 15 shows in cross section a method by which electrodes used to address one row of resistive heating elements might “tunnel” underneath the electrodes used to address a second row. Thus, electrode 124 might be used to address a first row, and electrode 126 might be used to address a second row. Separating the electrodes is a layer of electrically insulating material 128. The resistive heating elements 132 might be located in two separate planes, as shown, or in the same plane, if appropriate filler layers are employed (as would be clear to one of skill in the art). Wherever the resistive heating elements are located, the connections 130 to both rows of resistive heating elements are on the same side of the array.

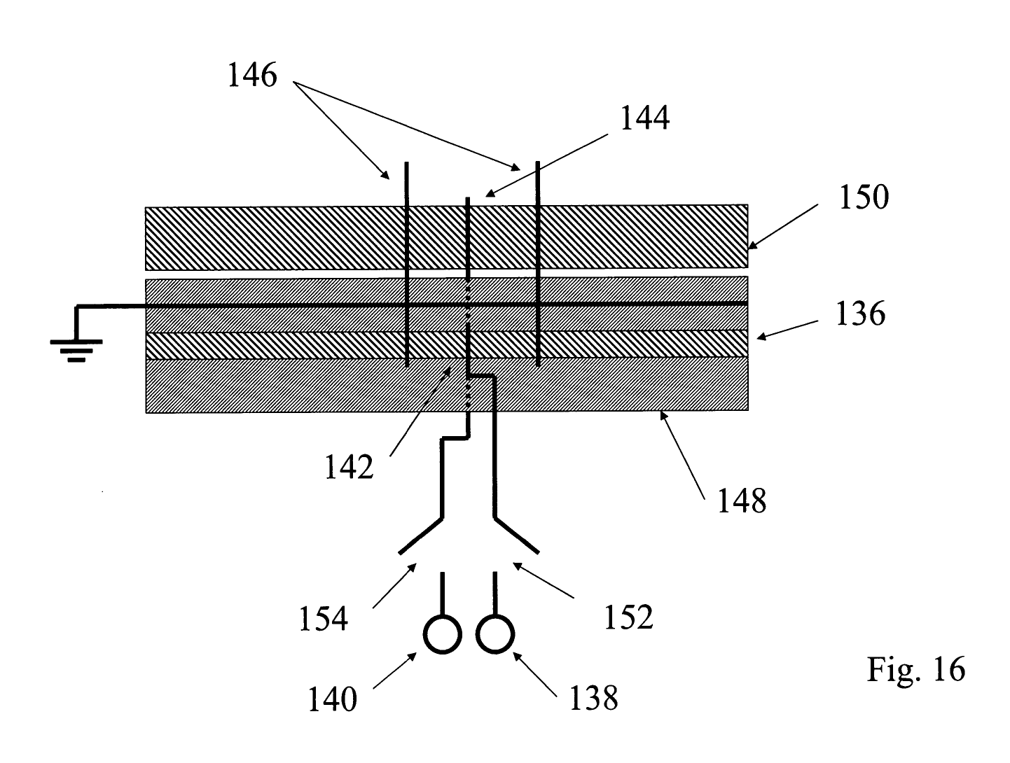

FIG. 16 shows in plan view the implementation of more than one plane of electrodes in a resistive heating element design similar to that shown in FIG. 9, but the same concept may be applied to any of the designs in FIGS. 9-12. In this design, the electrodes that connect the resistive heating elements to the driving circuitry are not in the same plane. Electrode 142 is connected to electrical power through switch 152 and connector 138, while electrode 144 is connected to electrical power through switch 154 and connector 140. Electrode 144 passes under electrode 142, and the two are separated by a plane of insulating material 148. Electrode 144 connects to resistive material 150, and electrode 142 connects to resistive material 136. Strips of resistive material are shown, but alternatively individual resistors may be deposited.

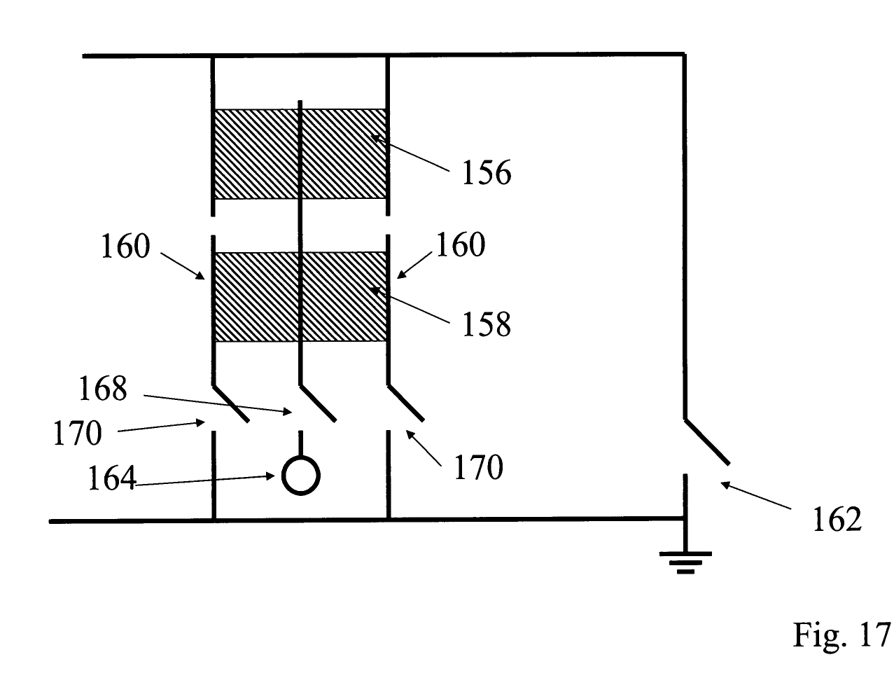

FIG. 17 shows a design for the resistive heating elements of a thermal printing head of the present invention having two rows of resistive heating elements 156 and 158 in which all switching connections are on the same side of the array and all the electrodes are located in the same plane. In each row, the electrodes addressing each resistive heating element are perpendicular to the row. Each element of either row is individually addressable but not at the same time. When both rows are addressed simultaneously, a pair of corresponding pixels in each row must be addressed. When switches 170 are open and switch 162 is closed, resistive heating element 156 is addressed through switch 168. When switch 162 is open, resistive heating element 158 is addressed though switches 168 and 170 operated in tandem. There will be some leakage in this case through the neighboring pixel via resistor 156 and the shared electrodes 160, but this is minimized if the resistance of 156 is greater than that of 158.

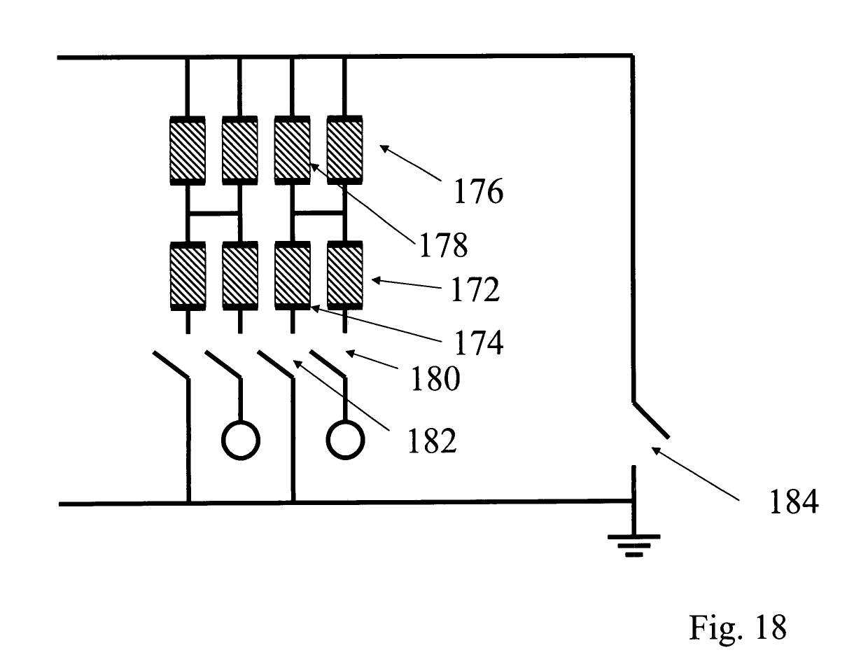

FIG. 18 shows a design for the resistive heating elements of a thermal printing head of the present invention having two rows of paired resistive heating elements 172, 174 and 176, 178 in which all switching connections are on the same side of the array and all the electrodes are located in the same plane. In each row, the electrodes addressing each resistive heating element are parallel to the row. Each element of either row is individually addressable but not at the same time. When both rows are addressed simultaneously, a pair of corresponding pixels in each row must be addressed. Two addressable pixels in each row are shown. When switch 182 is open and switch 184 is closed, resistive heating elements 176 and 178 are addressed through switch 180 and resistive heating element 172. The heating in resistive heating element 172 is minimized if the resistance of 176 and 178 is higher than that of 172. When switch 184 is open, resistive heating elements 172 and 174 are addressed though switches 180 and 182 operated in tandem.

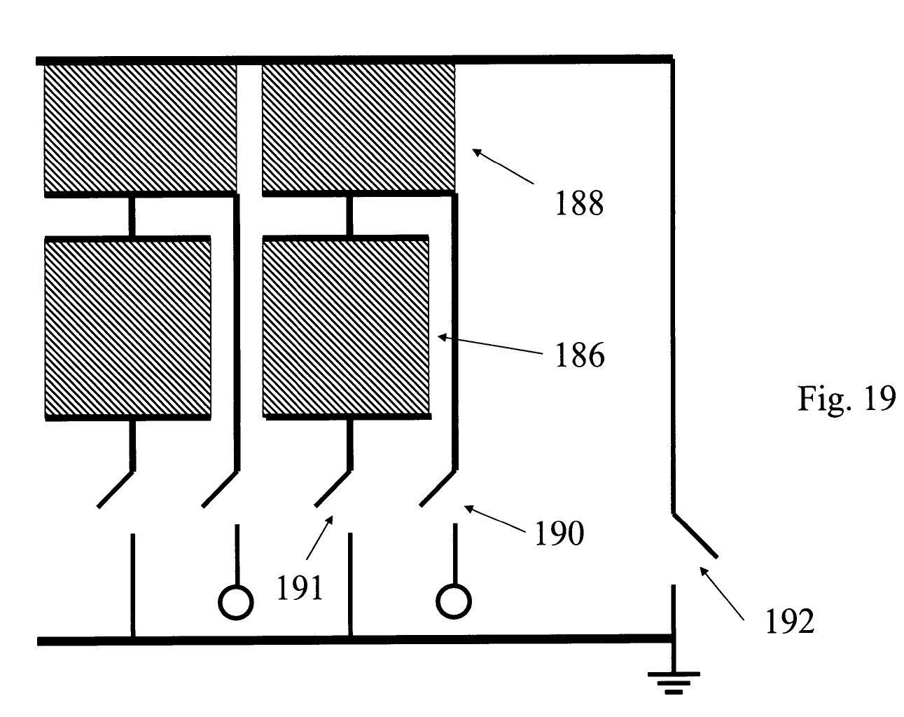

FIG. 19 shows a similar design for the resistive heating elements of a thermal printing head of the present invention having two rows of resistive heating elements 186 and 188 in which all switching connections are on the same side of the array and all the electrodes are located in the same plane. In each row, the electrodes addressing each resistive heating element are parallel to the row. Each element of either row is individually addressable but not at the same time. When both rows are addressed simultaneously, a pair of corresponding pixels in each row must be addressed. Two addressable pixels in each row are shown. When switch 192 is open, resistive heating element 186 is addressed through switches 190 and 191 operated in tandem. When switch 192 is closed and switch 191 is open, resistive heating element 188 addressed though switch 190.

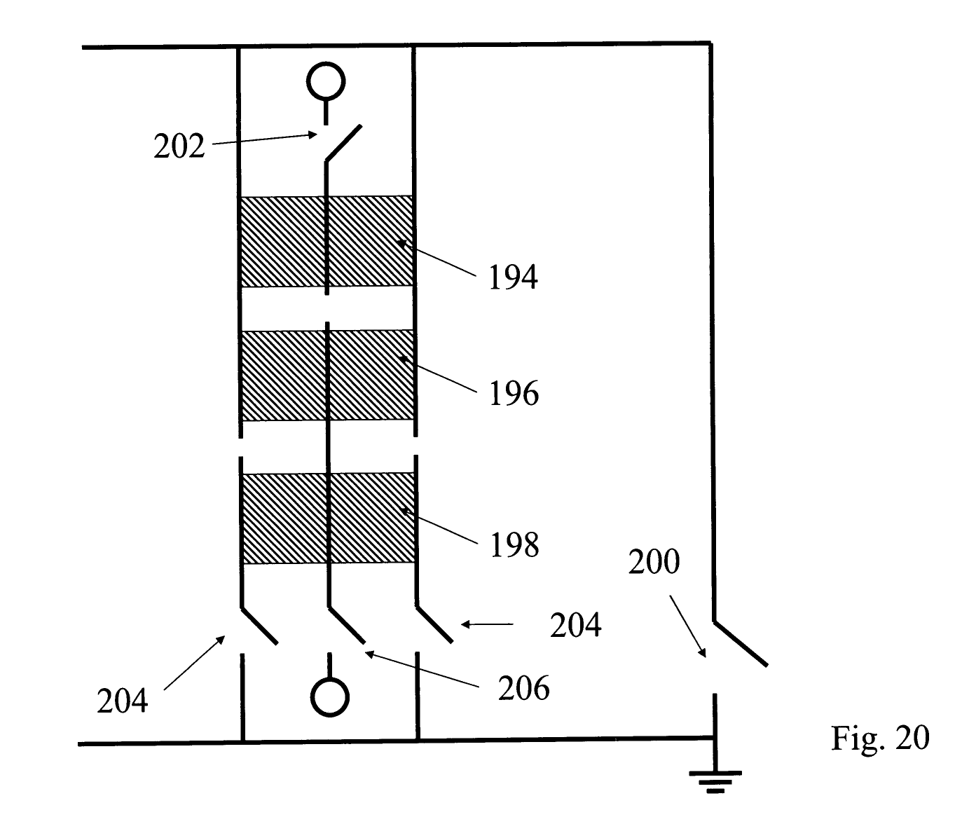

FIG. 20 shows a design for the resistive heating elements of a thermal printing head of the present invention having three rows of resistive heating elements 194, 196 and 198 in which switching connections are on the both sides of the array if all the electrodes are located in the same plane. In each row, the electrodes addressing each resistive heating element are perpendicular to the row. Each element of any row is individually addressable but the rows are not addressable at the same time. When switch 200 is open, resistive heating element 198 is addressed through switches 206 and 204 operated in tandem. When switch 200 is closed and switches 204 are open, resistive heating element 194 is addressed though switch 202. When switch 200 is closed and switches 204 are open, resistive heating element 196 is addressed though switch 206.

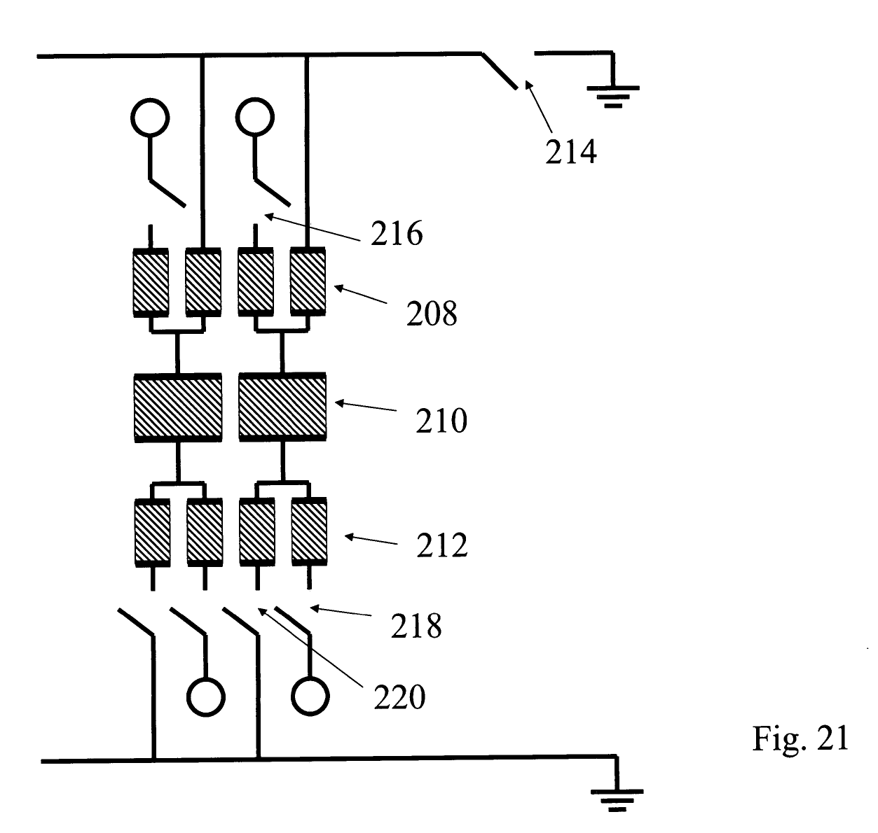

FIG. 21 shows a design for the resistive heating elements of a thermal printing head of the present invention having three rows of resistive heating elements 208, 210 and 212 in which switching connections are on the both sides of the array if all the electrodes are located in the same plane. As mentioned above, if more than one plane of electrodes is used, all connections could be on the same side of the array. In each row, the electrodes addressing each resistive heating element are parallel to the row. Each element of any row is individually addressable but the rows are not addressable at the same time. When switch 220 is open and switch 214 is closed, resistive heating elements 208 are addressed through switch 216, and resistive heating element 210 is addressed through switch 218 and the right hand resistive heating element of each of the pairs 208 and 212. For this reason, resistive heating elements 208 and 212 are preferred to have a lower resistance than resistive heating element 210. When switch 214 is open, resistive heating elements 212 are addressed though switches 218 and 220 operated in tandem. As mentioned above, the resistive heating elements and electrodes shown schematically in FIGS. 9-21 are not drawn to scale, and may be of any relative or absolute size. A typical resistive heating element used for formation of an image will have a width of about 5 to about 200 microns and a length of about 20 to about 500 microns, although these dimensions are quoted for the purpose of illustration only and are not intended to limit the invention in any way.

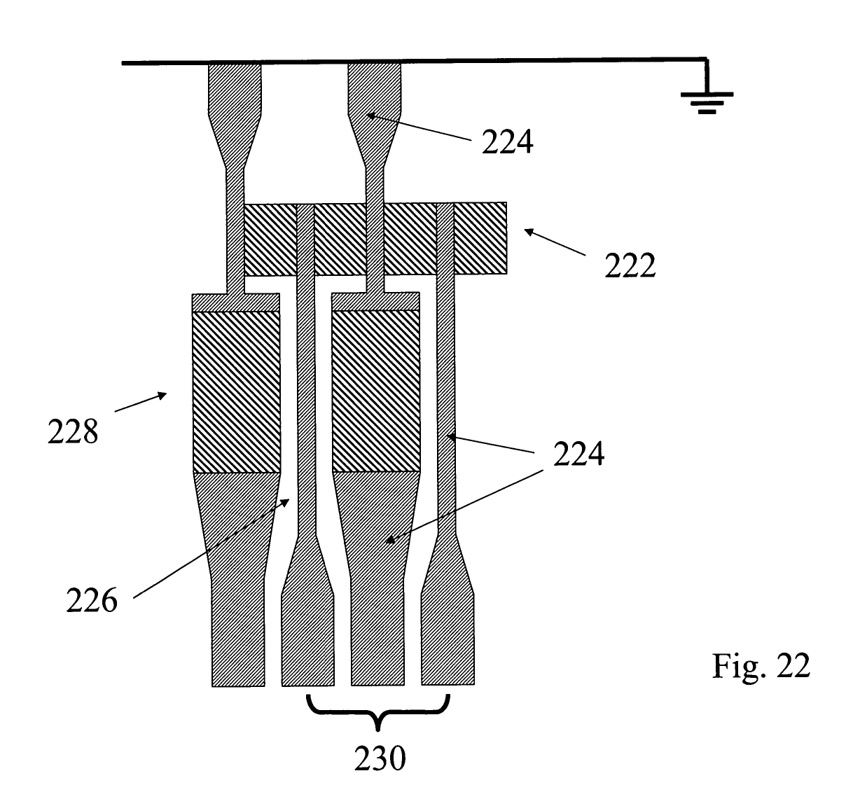

FIG. 22 shows an arrangement of electrodes 224 and resistive heating elements 222 and 228 that is shown approximately to scale, and has the basic architecture described above with reference to FIG. 13, with the omission of the switches. The electrodes may be made out of any appropriately conductive material, for example a metal such as aluminum. The electrodes may be patterned onto a substrate using methods that are well known in the art, such as various photolithographic/etching techniques or other deposition techniques. In the current state of the art, the minimum width of electrode features is approximately 10 micrometers, and the minimum width of a gap between electrodes such as gap 226 in FIG. 22 is also approximately 10 micrometers. The thickness of the electrodes is typically between about 0.1 micrometers and about 2 micrometers. The resistive heating elements 222 and 228 may have widths of approximately 32.5 and 55 micrometers, respectively, such that the pitch 230 of the individually addressable pixels in each row of resistive heating elements is approximately 85 micrometers, giving a resolution of about 300 dots per inch for each row. As mentioned above, the lengths of the resistive heating elements 222 and 228 may be chosen so as to give the best results when printing onto a multicolored direct thermal imaging member, and may range from about 10 to about 500 micrometers in length.

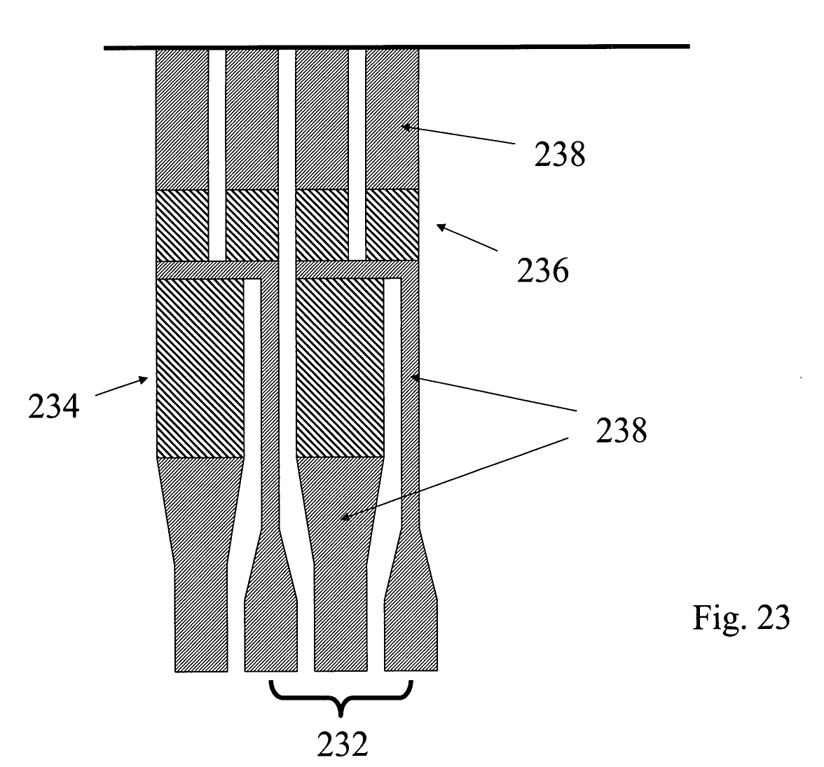

FIG. 23 shows an arrangement of electrodes 238 and resistive heating elements 234 and 236 that is shown approximately to scale, and has the basic architecture described above with reference to FIG. 19, with the omission of the switches. In this case, resistive heating element 188 in FIG. 19 is rendered as a pair of resistive heating elements 236 in FIG. 23. The dimensions and the methods and materials used to make the electrodes and resistive heating elements may be as described above with reference to FIG. 22.

The resistive heating elements and electrodes of the preferred thermal printing heads of the present invention discussed above with reference to FIGS. 9-23 may be disposed on any appropriate substrate. The substrate may be composed of any appropriate material. Such materials include, but are not limited to, amorphous materials such as ceramics, glasses, and plastics, and crystalline materials such as crystalline silicon. The shape of the substrate may be planar, curved in one or two dimensions, or irregular. The resistive heating elements and electrodes may be overcoated with protective layers. Such layers are well known in the art, and are typically abrasion-, chemical- and heat-resistant glazes and the like.

Any method of switching (i.e., addressing) the individual resistive heating elements may be used that is consistent with the basic architecture outlined schematically in FIGS. 9-23.

Although the invention has been described in detail with respect to various preferred embodiments, it is not intended to be limited thereto, but rather those skilled in the art will recognize that variations and modifications are possible which are within the spirit of the invention and the scope of the appended claims.

We claim:

1. A multicolor thermal imaging method comprising:
(a) providing a thermal imaging member comprising at least a first image-forming composition forming a first color when heated and a second image-forming composition forming a second color when heated, the first and second colors being different from each other;
and
(b) heating the thermal imaging member with a thermal printing head while the thermal imaging member and the thermal printing head are in relative motion so as to form an image in which the first and second colors are present in selectable proportions,
wherein the thermal printing head comprises more than one row of resistive heating elements, the rows being oriented substantially perpendicular to the direction of relative motion of the thermal printing head and the thermal imaging member.

2. The method of claim 1 further comprising addressing the first color using one of the more than one row of heating elements that is not used to address the second color.

3. The method of claim 1, wherein the maximum temperature attained by any resistive heating element in one of the more than one row of resistive heating elements when printing an image of maximum density is at least about 20° C. higher than the maximum temperature attained by any resistive heating element in a different one of the more than one row of resistive heating elements when printing an image of maximum density.

4. The method of claim 1, wherein a number of resistive heating elements per unit length in one of the more than one row of resistive heating elements is different from a number of resistive heating elements per unit length in a different one of the more than one row of resistive heating elements.

5. The method of claim 1, wherein an average resistance of the resistive heating elements in one of the more than one row of resistive heating elements is different from an average resistance of the resistive heating elements in a different one of the more than one row of resistive heating elements by a factor of at least about 1.5.

6. The method of claim 1, wherein a shape of the resistive heating elements in one of the more than one row of resistive heating elements is different from a shape of the resistive heating elements in a different one of the more than one row of resistive heating elements.

7. The method of claim 1, wherein an average length of the resistive heating elements in one of the more than one row of resistive heating elements is different from an average length of the resistive heating elements in a different one of the more than one row of resistive heating elements by a factor of at least about 1.5.

8. The method of claim 1, wherein the thermal imaging member further comprises a third image-forming composition forming a third color when heated.

9. The method of claim 1, wherein the thermal printing head comprises two rows of resistive heating elements.

10. The method of claim 1, wherein the thermal printing head comprises three rows of resistive heating elements.

11. The method of claim 10, wherein a middle row of the three rows of resistive heating elements of the thermal printing head comprises a single resistive heating element, and non-middle rows of the three rows of resistive heating elements are of substantially the same width.

12. The method of claim 1 further comprising:
(c) supplying a voltage to one of the more than one row of resistive heating elements; and
(d) supplying a different voltage to a different one of the more than one row of resistive heating elements.

13. The method of claim 1 further comprising:
(c) sending data having a first correction to one of the more than one row of resistive heating elements; and
(d) sending data having a second correction different from the first to a different one of the more than one row of resistive heating elements.

14. The method of claim 13, wherein each of the first and second corrections is independently selected from the group consisting of: compensation for thermal history; compensation for common mode voltage drop; compensation for dot pattern streaks caused by nonuniformities in the printing head manufacturing; and combinations thereof.

15. A thermal printing head comprising:
a first row of resistive heating elements having a first physical property; and
a second row of resistive heating elements positioned adjacent to the first row and having a second physical property different from the first, the first and second rows of resistive heating elements adapted to form an image on a thermal imaging member.

16. The thermal printing head of claim 15, wherein each of the first and second physical properties is selected from the group consisting of: number of resistive heating elements per unit length; average resistance of resistive heating elements; shape of resistive heating elements; length of resistive heating elements measured in a direction perpendicular to the row; and combinations thereof.

17. The thermal printing head of claim 15, wherein each of the first and second physical properties is a number of resistive heating elements per unit length, a number of resistive heating elements per unit length in the first row of resistive heating elements being different from a number of resistive heating elements per unit length in the second row of resistive heating elements.

18. The thermal printing head of claim 15, wherein each of the first and second physical properties is an average resistance of the resistive heating elements in the respective first and second row of resistive heating elements, an average resistance of the resistive heating elements in the first row of resistive heating elements being different from an average resistance of the resistive heating elements in the second row of resistive heating elements by a factor of at least about 1.5.

19. The thermal printing head of claim 15, wherein each of the first and second physical properties is shape of the resistive heating elements in the respective first and second row of resistive heating elements, a shape of the resistive heating elements in the first row of resistive heating elements being different from a shape of the resistive heating elements in the second row of resistive heating elements.

20. The thermal printing head of claim 15, wherein each of the first and second physical properties is an average length of the resistive heating elements within the respective first and second rows of resistive heating elements, an average length of the resistive heating elements in the first row of resistive heating elements, as measured in the direction perpendicular to the first row, being different from an average length of the resistive heating elements in the second row of resistive heating elements, as measured in the direction perpendicular to the second row, by a factor of at least about 1.5.

21. The thermal printing head of claim 16, wherein the thermal printing head comprises two rows of resistive heating elements.

22. The thermal printing head of claim 16, wherein the thermal printing head comprises three rows of resistive heating elements.

23. The thermal printing head of claim 16, wherein a middle row of the three rows of resistive heating elements of the thermal printing head comprises a single resistive heating element, and the non-middle rows of the three rows of resistive heating elements are of substantially the same width.
